(19) United States
(12) Patent Application Publication
(10) Pub. No.: US 2018/0142845 A1
(43) Pub. Date: May 24, 2018

(54) WIRELESS LED LAMP WITH MULTI-FUNCTIONAL CHARGER

(71) Applicant: DAWON ELECTRONICS CO., LTD., ANSAN-SI (KR)

(72) Inventor: JAE-MYEONG LEE, ANSAN-SI (KR)

(21) Appl. No.: 15/359,490

(22) Filed: Nov. 22, 2016

(51) Int. Cl. F21L 4/08; H05B 33/08; H05B 37/02; F21V 23/06; F21V 21/08; F21V 23/04; H02J 7/35; H02J 7/00; F04D 25/06

(52) U.S. Cl. CPC F21L 4/08; H05B 33/0845; H05B 37/0281; F21V 23/06; F21Y 2115/10; F21V 23/0414; H02J 7/355; H02J 7/0052; F04D 25/0673; F21V 21/08

(57) ABSTRACT

A wireless LED lamp having a multi-functional charger which includes an LED lamp having a male terminal unit that rotationally couples to a female unit of the charger. The charger charges a battery through a solar cell panel, home electricity and a vehicle cigar jack, so that the LED lamp can be wirelessly used as an indoor light or an outdoor lantern. The charger has a first charging port connected to DC 24 V and a second charging port connected to DC 12V. A regulator and a charging circuit to convert the DC 24V into DC 12V and to charge a battery with the DC 12V are embedded in the charger. The charger has a lamp controller to supply power to and control illumination of the LED lamp. The charger can be coupled to a portable appliance having a female terminal unit having the same shape as the LED lamp.

### FIELD OF THE INVENTION

The present invention relates to a wireless LED lamp with a multi-functional charger, and more particularly, to a wireless LED lamp with a multi-functional charger, which includes an LED lamp having a male terminal unit provided with a thread formed on an outer peripheral surface thereof to be coupled to a general home socket, and a charger having a female terminal unit provided with a thread formed on a bottom inner peripheral surface thereof to be coupled to the male terminal unit so that the charger charges a battery through a solar cell panel, home electricity or a vehicle cigar jack, thereby being used wirelessly as an indoor light or an outdoor lantern anywhere. Additionally, if a fan has a male terminal unit with the same shape as the male terminal unit of the LED lamp, the charger can be utilized as a power source for the fan.

### BACKGROUND OF THE INVENTION

About 98% of LED lamps which are currently on the market are LED lamps for AC and about 2% are LED lamps for DC, and all of them are designed to illuminate through a socket by receiving electricity from the outside. Moreover, some of electric bulbs are formed in a fixed type to be fixed on the wall or the ceiling or some of the electric bulbs are used by being connected with a cord of 3M or 5M. Such LED lamps have a disadvantage in that they require installation of electric wires in order to be used at a target place.

Korean Patent Nos. 1064204 and 1094410 and Korean Utility Model Publication No. 2011-0009095 disclose LED lamps each of which includes a batter embedded therein and a male screw part formed on the outer surface thereof to be screw-coupled with a socket fixed on a wall so that the battery embedded therein can be charged while the LED lamp is usually utilized as lighting. Therefore, because the LED lamp can be carried after being separated from the socket when the batter is charged completely, the LED lamp is usable as a lantern which illuminates by electric power of the battery.

However, such prior arts have several disadvantages in that standardized LED lamps which are on the market cannot be used and the LED lamps require lots of repairing charges when they break down because LED lamps in which batteries are embedded must be manufactured newly, and in that the batteries cannot be utilized to other home appliances because the batteries are embedded in the LED lamps.

Korean Patent No. 987460 discloses an LED lamp which includes a plurality of illumination members connected with each other so as to be used as a lamp, wherein the illumination members are connected with each other by wire and are combined to a stand, which receives electric power, to be supplied with electric power. In this instance, one of the illumination members has a battery embedded therein so as to be charged with power. Therefore, when the charged illumination member is separated from another illumination member, it can be utilized as a lantern.

However, such a prior art also has several disadvantages in that it requires a stand which is connected with commercial electricity for home and lots of the illumination members and in that it is complicated in structure because a battery is embedded in the separated illumination member. Furthermore, the prior art also has a disadvantage in that it is difficult to replace the lamp because the lamp according to the prior art is not a standardized LED lamp which can be easily obtained on the market.

### OBJECT AND SUMMARY OF THE INVENTION

Accordingly, the present invention has been made in view of the above-mentioned problems occurring in the prior art, and it is an object of the present invention to provide a wireless LED lamp with a multi-functional charger, which includes an LED lamp having a male terminal unit provided with a thread formed on an outer peripheral surface thereof to be coupled to a general home socket, and a charger having a female terminal unit provided with a thread formed on a bottom inner peripheral surface thereof to be coupled to the male terminal unit so that the charger charges a battery through a solar cell panel, home electricity or a vehicle cigar jack, thereby being used wirelessly as an indoor light or an outdoor lantern anywhere, and being replaceable easily because the LED lamp has the standardized male terminal unit which can be easily obtained on the market.

It is another object of the present invention to provide a wireless LED lamp with a multi-functional charger which includes the charger utilizable as a power source for a wireless fan when a male terminal unit of the fan is coupled with the female terminal unit of the charger separated from the LED lamp.

It is a further object of the present invention to provide a wireless LED lamp with a multi-functional charger in which the charger has a generator embedded therein and a wire is connected to a hook part for hanging the charger to rotate the generator, so that the generator rotates to produce electricity while a process that the wire is pulled and wound on a spring is repeated when a user pulls the hook part, thereby being utilized for emergency purposes because the battery can be charged by minimum power under emergency situations that the battery cannot be charged through a solar cell panel, a switched-mode power supply (SMPS) or a vehicle cigar jack.

To accomplish the above object, according to the present invention, there is provided a wireless LED lamp with a multi-functional charger comprising: an LED lamp having a male terminal unit provided with a thread formed on an outer peripheral surface of an upper part thereof; and a charger having a battery embedded therein and a female terminal unit provided with a thread formed on an inner peripheral surface of a lower part thereof and coupled with the male terminal unit to be connected on a circuit, wherein the charger includes a first charging port connected with DC 24V, a second charging port connected with DC 12V and a regulator and a charging circuit for converting DC 24V into DC 12V to charge the battery, and the charger further includes a lamp controller for supplying electricity to the LED lamp and controlling illumination. In addition, the charger can be coupled to a mobile device having a male terminal unit of the same shape as the male terminal unit of the LED lamp when electric power to the lamp controller is cut off.

As described above, according to the preferred embodiment of the present invention, there is no need to additionally manufacture LED lamps because the wireless LED lamp the wireless LED lamp according to the present invention adopts the standardized male terminal unit which can be easily obtained on the market. Moreover, the charger can be screw-coupled with the male terminal unit because having the female terminal unit having the thread formed on the inner peripheral surface so as to be separated from the LED lamp for DC 12V. Furthermore, the LED lamp has the battery and the charging control circuit unit embedded therein, and the lamp controller for controlling brightness and illumination time is also embedded in the LED lamp. Therefore, the LED lamp can control brightness of the lamp through a dimming function used for usually studying or sleeping at home.

When the male terminal unit of the LED lamp is coupled to the female terminal unit of the charger, the charger can be used as a portable lantern, and can be utilized as indoor illumination when the charger is hung wirelessly anywhere the user wants. In addition, because the female terminal unit of the charger adopts the coupling structure with the international standard, such as E23 or E26, which fits with the male terminal unit of the standardized lamp easily obtainable on the market, the LED lamp can be easily purchased and replaced.

Furthermore, the wire is connected to the hook part of the charger so that the charger can be hung on the wall or the ceiling, and the wire is wound on the pulley of the generator embedded in the charger. Therefore, while the process that the wire is released when the user pulls the hook part and is wound by the spring is repeated, the pulley rotates to operate the generator, so that the battery can be charged with the minimum capacity under emergency situations that the user cannot obtain external electricity.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a conceptual diagram of a wireless LED lamp according to a preferred embodiment of the present invention;

FIG. 2 is a view showing a used state of the wireless LED lamp;

FIG. 3 is a circuitry block diagram of a charger of the wireless LED lamp; and

FIG. 4 is a partially enlarged view of the charger of the wireless LED lamp.

### DETAILED DESCRIPTION OF THE PREFERRED EMBODIMENT

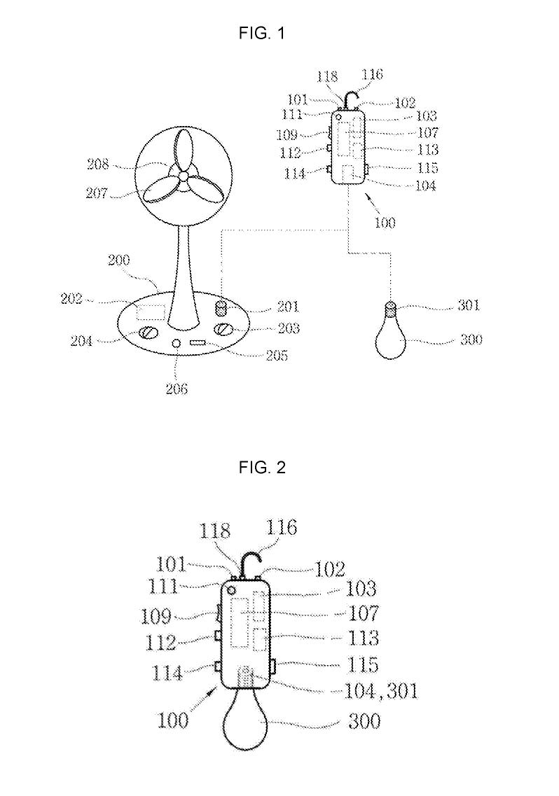

In FIGS. 1 to 4, a wireless LED lamp 300 according to a preferred embodiment of the present invention includes: a male terminal unit 301 having a thread formed on an outer peripheral surface of an upper part thereof; and a charger 100 detachably assembled with the male terminal unit 301. The LED lamp 300 is a standardized product which can be easily obtained on the market. Moreover, the charger 100 has a female terminal unit 104, which is concavely formed on the bottom surface thereof and has a thread formed on the inner peripheral surface to be coupled with the male terminal unit 301. When the male terminal unit 301 and the female terminal unit 104 are coupled with each other, the charger 100 and the LED lamp 300 are connected with each other on a circuit.

The charger 100 includes a first charging port 101 and a second charging port 102 disposed at both sides of the upper face and a hook part 116 formed at the center of the upper face for allowing a user to hang the charger 100 on the ceiling or a string. The first charging port 101 is connected with a solar cell panel, an SMPS connected with general home power source, or a DC 24V vehicle cigar jack, and the second charging port 102 is connected with a DC 12V vehicle cigar jack.

The charger 100 further includes: a power switch 109 for providing an ON/OFF function, a selection switch 112, an illumination control switch 114 and an USB terminal unit 115 which are disposed on the flank of the charger 100. A male terminal unit 201 of a fan, which will be described later, or the male terminal unit 301 of the LED lamp 300 may be coupled to the female terminal unit 104, and in this instance, the selection switch 112 is in charge of setting the charger 100 to fit to the fan or the LED lamp 300. The illumination control switch 114 is to control brightness of the LED lamp 300. Light of the LED lamp 300 becomes dim when the user presses the illumination control switch 114 for about three seconds, but is restored to original brightness when the user presses it for about three seconds again. The USB terminal unit 115 is used when the selection switch 112 selects the LED lamp 300.

A charging display lamp 111 is disposed on the front face of the charger 100 to display a charged state of the embedded battery 107 with three colors. Moreover, the battery 107, a constant voltage regulator 108 and a lamp controller 113 are disposed inside the charger 100.

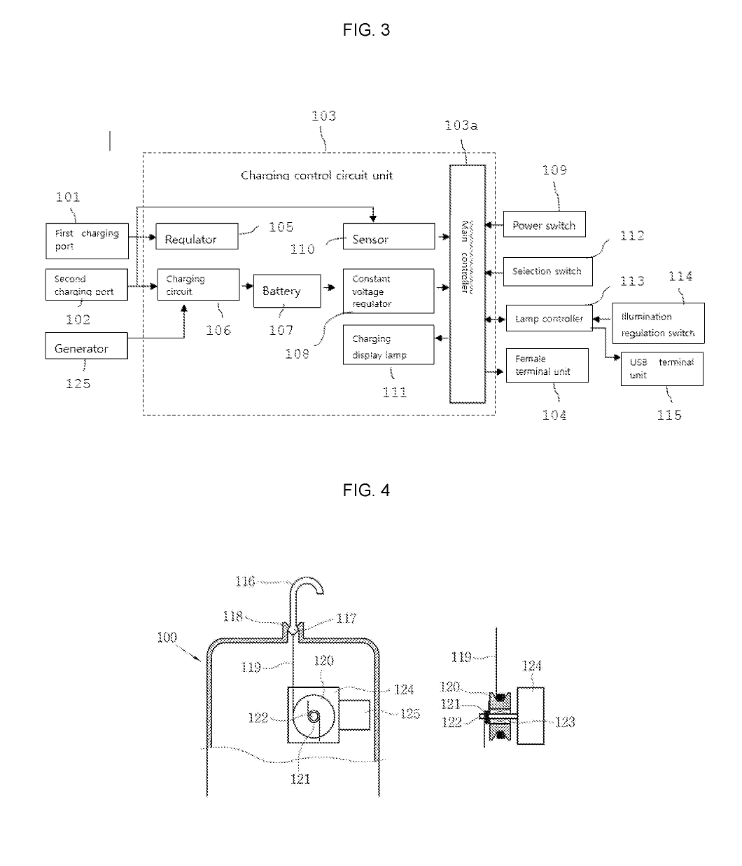

In FIG. 3, the charging control circuit unit 103 includes: a regulator 105 directly connected with the first charging port 101; a charging circuit 106 connected with the second charging port 102 and the regulator 105; the constant voltage regulator 108 connected with the charging circuit 106; and a main controller 103a for controlling that electric power applied from the constant voltage regulator 108 is supplied to the female terminal unit 104.

Additionally, the main controller 103a of the charging control circuit unit 103 is connected with a sensor 110 for sensing contact signals of the first charging port 101 and the second charging port 102, and the selection switch 112, the power switch 109, the lamp controller 113 and the charging display lamp 111 are connected to the main controller 103a. Moreover, the lamp controller 113 is connected with the illumination control switch 114 and the USB terminal unit 115.

FIG. 4 illustrates a structure that the charger independently generates power. A small-sized generator 125 connected with a reducer 124 is embedded in the charger 100, and a pulley 120 on which a wire 119 is wound is disposed on the reducer 124. A driving shaft 122 of the pulley 120 is connected with the reducer 124, and the driving shaft 122 and the pulley 120 are connected through a ratchet 123 which rotates only in one direction. In addition, the hook part 116 disposed on the outer face of the charger 100 has a retaining jaw 117 formed on the lower end, and the charger 100 has a retaining member 118 formed on the surface of the charger to hold the retaining jaw 117. Moreover, an end of the wire 119 is connected with the retaining jaw 117, so that the pulley 120 is rotated while the wire 119 is pulled together with the hook part 116. Furthermore, the pulley has a spring 121 disposed on the flank thereof so that the pulley 120 always rotates in the direction that the wire 119 is wound.

As described above, the battery 107 of the charger of the LED lamp according to the preferred embodiment of the present invention is a lithium iron phosphate battery which has capacity of 12.8V/3 A, 5 A or 10 A, 36 W. When 3 W LED lamp 300 is use, it can be used for continuous 10 hours at efficiency of 80%.

The LED lamp 300 according to the preferred embodiment of the present invention has several advantages in that it is convenient in replacement and repair of the charger 100 because the charger 100 and the LED lamp 300 are separated from each other and in that the operational time of the LED lamp can be enlarged as must as the number of the chargers because the charger 100 can be replaced with a new one when the user previously prepares a plurality of the chargers 100 of the same standard. Moreover, while one charger combined to the LED lamp is used wirelessly, because another charger may be charged, the LED lamp can be used continuously by radio.

When electric power of DC 24V is supplied to the first charging port 101 through a solar cell panel, an SMPS connected with general home power source or a vehicle cigar jack, voltage is dropped and outputted to DC 12V through the regulator 105, and charges the battery 107 through the charging circuit 106 serving to prevent overvoltage. In case of a car which is charged through a DC 12V cigar jack, DC 12V is inputted through the second charging port 102 and charges the battery 107 through the charging circuit 106 without passing through the regulator 105, and in this instance, the main controller 103a is operated to display red on the charging display lamp 111.

When power source is applied through the solar cell panel, the cigar jack or the SMPS and the power switch 109 is turned on, the main controller 103a senses it through the sensor 110 and controls in such a way that the power source is applied to the female terminal unit 104 through the constant voltage regulator 108. When the charger 100 is screw-coupled with the male terminal unit 301 of the LED lamp 300 through the female terminal unit 104 and the selection switch 112 selects the LED lamp, electricity of the battery 107 is applied to the lamp controller 113.

The lamp controller 113 is relayed to apply electricity to the USB terminal unit 115 and supply electricity to the LED lamp 300. Because the lamp controller 113 is connected with the illumination control switch 114, when the switch is regulated, brightness of the lamp can be controlled. Therefore, the LED lamp 300 can realize dimming for sleeping. The illumination control switch 114 controls brightness of the LED lamp 300 in two steps. Additionally, the USB terminal unit 115 receives electricity through the lamp controller 113.

Moreover, the charger 100 has the charging display lamp 111 to display the charged state of the battery 107, so that the user can check the used hours. The charging display lamp 111 can realize three colors, i.e., green meaning full charging, yellow meaning intermediate charging, and red meaning necessity of charging, and senses voltage of the battery 107 through the main controller 103a. The main controller 103a controls the charging display lamp 111 to display green meaning full charging when voltage of the battery is DC 13.5V to DC 14.6V, yellow meaning intermediate charging when voltage of the battery is DC 10.6V to DC 13.4V, and red meaning necessity of charging when voltage of the battery is DC 9V to DC 10.5V.

FIG. 4 illustrates that the charger 100 independently generates power. If self-generation is needed, when the user pulls the hook part 116 upwardly, the retaining jaw 117 gets out of the retaining member 118 and is separated from the charger 100. When the user strongly pulls the separated hook part 116 upwardly, the pulley 120 is rotated while the spring 121 is wound and compressed, and in this instance, the generator 125 is rotated to produce electricity through the reducer 124 connected with the pulley 120 through the driving shaft 122. When the user releases the pulled hook part 116, the pulley 120 rotates in the reverse direction by restoring force of the spring 121, and in this instance, by the ratchet 123, the driving shaft 122 maintains a stopped state but the wire 119 is wound on the pulley 120. After that, when the user rapidly repeats the process of pulling and releasing the hook part 116, electricity is generated due to acceleration power applied to the generator 125 while the pulley 120 rotates forwardly, and so, charges the battery 107 through the charging circuit 106 of the charger 100.

Therefore, the user can cope with emergency by using minimum capacity of the battery 107 in a region where the user cannot obtain electricity through the solar cell panel, the SMPS or the cigar jack.

Moreover, when the male terminal unit 201 of the fan 200 is coupled to the female terminal unit 104 of the charger 100 after the charger 100 is separated from the LED lamp 300, the charger 100 can be utilized as a wireless fan. For this, when the selection switch 112 of the charger 100 selects the fan, the main controller 103a senses it and the fan controller 202 controls to supply electricity to a fan motor 208.

The fan 200 has a fan controller 202 disposed therein. The fan controller 202 controls a timer 204, an air volume control switch 203, an USB terminal unit 205 and a charging display lamp 206 which are disposed on the surface of the fan 200. Additionally, the fan controller 202 is connected with the male terminal unit 201 on a circuit so as to guide that electricity of the battery 107 of the charger 100 is applied to the fan motor 208 for rotating fan blades 207.

1. A wireless LED lamp with a multi-functional charger, comprising:
an LED lamp having a male terminal unit provided with a thread formed on an outer peripheral surface of an upper part thereof;
a charger having a battery embedded therein and a female terminal unit provided with a thread formed on an inner peripheral surface of a lower part thereof, the female terminal unit rotationally couples with the male terminal unit to connect to a circuit;
wherein the charger comprises a first charging port connected with DC 24V, a second charging port connected with DC 12V, a regulator and a charging circuit for converting DC 24V into DC 12V to charge the battery;
wherein the charger further comprises a lamp controller to supply electricity to the LED lamp, an illumination control switch connected to the lamp controller to control an illumination of the LED lamp, and a selection switch to cut off the electricity supplied to the lamp controller; and
wherein when electricity supplied to the lamp controller is cut off by the selection switch, the charger is coupled to a mobile device having a male terminal unit of a same shape as the male terminal unit of the LED lamp.

2. The wireless LED lamp according to claim 1, wherein the first charging port is connected to a solar cell panel, an SMPS connected with a home power source or a DC 24V vehicle cigar jack.

3. The wireless LED lamp according to claim 2, wherein the second charging port is connected to the DC 24V vehicle cigar jack.

4. The wireless LED lamp according to claim 1, further comprising a USB terminal unit which receives electricity through the lamp controller; and wherein the USB terminal and the illumination control switch are disposed on an outer peripheral surface of the charger.

5. The wireless LED lamp according to claim 1, further comprising a generator connected to a reducer is disposed inside the charger, wherein the reducer is connected to a pulley, on which a wire is wound, through a driving shaft; wherein the charger comprises a hook part detachably combined to an upper part thereof to hang the charger on a wall or a ceiling so that the LED lamp is usable as an indoor light, and a lower end of the hook part is connected to an end of the wire; wherein the pulley rotates in one direction and the generator is rotated through the reducer to charge the battery in response to a pulling of the hooked part.
